(19) United States
(12) Patent Application Publication
(10) Pub. No.: US 2026/0050325 A1
(43) Pub. Date: Feb. 19, 2026

(54) ULTRASOUND-ENABLED RINGS CONFIGURED FOR INTERACTING WITH OTHER DEVICES AND SYSTEMS

(71) Applicant: QUALCOMM Incorporated, San Diego, CA (US)

(72) Inventors: Mohamed AHMED, San Marcos, CA (US); Nathan ALTMAN, Raanana (IL); Vadim WINEBRAND, San Diego, CA (US); Colby TRUDEAU, Encinitas, CA (US); Suhail JALIL, San Diego, CA (US); Thomas AMILIEN, San Diego, CA (US)

(21) Appl. No.: 18/809,165

(22) Filed: Aug. 19, 2024

(51) Int. Cl. G06F 3/01; A44C 9/00; G06F 3/0346

(52) U.S. Cl. CPC G06F 3/014; A44C 9/0053; G06F 3/017; G06F 3/0346; G06F 2203/0331

(57) ABSTRACT

An apparatus may include: a housing configured to be worn on at least a portion of a human hand or wrist; an inertial measurement unit (IMU) attached to the housing and configured to generate IMU data corresponding to an orientation of the apparatus; a wireless transmitter attached to the housing and configured to transmit radio frequency (RF) signals corresponding to the IMU data; an ultrasonic transmitter system attached to the housing and comprising one or more ultrasonic transmitters; and a control system attached to the housing and configured to: control a first ultrasonic transmitter of the ultrasonic transmitter system to produce first ultrasonic transmissions of a first ultrasonic transmission type; and control the wireless transmitter to transmit RF signals corresponding to the IMU data, the RF signals being synchronized with the first ultrasonic transmissions. The apparatus may be a ring that is configured to be worn on a human digit.

### TECHNICAL FIELD

This disclosure relates generally to user interaction methods, apparatus and systems, particularly user interactions involving hand gestures, hand motions, etc.

### DESCRIPTION OF THE RELATED TECHNOLOGY

Interacting with one or more devices using hand gestures, hand motions, etc., has become increasingly common. One category of use cases for such human/device interactions involves interactions with “extended reality” (XR) devices or systems. XR refers to all real-and-virtual combined environments and human-machine interactions, including augmented reality (AR), mixed reality (MR) and virtual reality (VR). The levels of virtuality in XR may range from sensory inputs that augment a user's experience of the real world to immersive virtuality, also called VR. Although some previously-deployed devices for indicating hand motions, gestures, etc., for interacting with XR systems can provide acceptable performance under some conditions, improved methods and devices would be desirable.

### SUMMARY

The systems, methods and devices of the disclosure each have several innovative aspects, no single one of which is solely responsible for the desirable attributes disclosed herein.

Some innovative aspects of the subject matter described in this disclosure may be implemented in an apparatus. In some examples, the apparatus may include a housing configured to be worn on at least a portion of a human hand or wrist. The apparatus may, for example, be a ring that is configured to be worn on a human digit. The apparatus may include an ultrasonic transmitter system attached to the housing and including one or more ultrasonic transmitters. The apparatus may include an inertial measurement unit (IMU) attached to the housing and configured to generate IMU data corresponding to an orientation of the apparatus. The apparatus may include a wireless transmitter attached to the housing and configured to transmit radio frequency (RF) signals. At least some of the RF signals may correspond to the IMU data. The apparatus may include a control system attached to the housing and configured to control a first ultrasonic transmitter of the ultrasonic transmitter system to produce first ultrasonic transmissions of a first ultrasonic transmission type and to control the wireless transmitter to transmit RF signals. At least some of the RF signals may correspond to the IMU data. At least some of the RF signals may be synchronized with the first ultrasonic transmissions. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

According to some examples, the control system may be further configured to control a second ultrasonic transmitter of the ultrasonic transmitter system to produce second ultrasonic transmissions of a second ultrasonic transmission type. The second ultrasonic transmissions may be synchronized with the RF signals. In some examples, the first ultrasonic transmission type may correspond to a first code and the second ultrasonic transmission type may correspond to a second code. According to some examples, the first ultrasonic transmission type may correspond to a first frequency and the second ultrasonic transmission type may correspond to a second frequency.

In some examples, the control system may include a flexible printed circuit board. In some such examples, at least a portion of the flexible printed circuit board may reside between the first ultrasonic transmitter and the second ultrasonic transmitter.

According to some examples, a least one ultrasonic transmitter of the ultrasonic transmitter system may be a micro-electromechanical system (MEMS) transducer. In some examples, at least one ultrasonic transmitter of the ultrasonic transmitter may be a piezoelectric transducer. In some examples, the housing may include a flexible portion that resides between the first ultrasonic transmitter and the second ultrasonic transmitter. According to some examples, the control system may be configured to control the first transducer to produce the first ultrasonic transmissions while controlling the second transducer to produce the second ultrasonic transmissions.

In some examples, the apparatus may be, or may include, a head-mounted device (HMD) such as a headset or an eyeglass frame. According to some examples, the HMD may include a microphone system, a display system and a control system. The microphone system may, in some examples, include three or more microphones. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system may be configured to control the display system to provide extended reality effects. In some examples, the control system may be configured to receive microphone signals from the microphone system. In some instances, the microphone signals may correspond to ultrasonic transmissions from each of a plurality of ultrasonic transmitters of one or more rings configured to be worn on a human digit. According to some examples, each transmitter of the plurality of ultrasonic transmitters may have a different ultrasonic transmission type. In some examples, the control system may be configured to determine a correspondence between each ultrasonic transmission type and each ultrasonic transmitter. According to some examples, the control system may be configured to determine a position and an orientation of the one or more rings based, at least in part, on the microphone signals.

In some examples, the HMD may include a wireless receiver configured to receive radio frequency (RF) signals corresponding to inertial measurement unit (IMU) data from an IMU of the one or more rings and to provide IMU data corresponding to received RF signals to the control system. In some such examples, the control system may be further configured to determine the position and the orientation of the one or more rings based, at least in part, on the IMU data.

According to some examples, the one or more rings may be a single ring that includes the plurality of ultrasonic transmitters. In other examples, the one or more rings may be a plurality of 2 or more rings. Each ring of the plurality of rings may include one or more ultrasonic transmitters. In some examples, the control system may be further configured to determine a hand motion or a hand gesture based, at least in part, on microphone signals corresponding to ultrasonic transmissions from the one or more rings. According to some examples, each of the ultrasonic transmission types may correspond to a different code or a different frequency from that of the other ultrasonic transmission types. In some examples, determining the position and the orientation of the one or more rings may involve a triangulation process that is based, at least in part, on the microphone signals.

Other innovative aspects of the subject matter described in this disclosure may be implemented in a system. In some examples, the system may include one or more rings configured to be worn on a human digit, including at least a first ring, and a head-mounted device (HMD) such as a headset or an eyeglass frame. According to some examples, the first ring may include an inertial measurement unit (IMU) configured to generate IMU data corresponding to an orientation of the apparatus. In some examples, the first ring may include a wireless transmitter configured to transmit radio frequency (RF) signals, at least some of which may correspond to the IMU data. According to some examples, the first ring may include an ultrasonic transmitter system comprising one or more ultrasonic transmitters.

In some examples, the first ring may include a first ring control system configured to control a first ultrasonic transmitter of the ultrasonic transmitter system to produce first ultrasonic transmissions of a first ultrasonic transmission type, and to control the wireless transmitter to transmit RF signals, at least some of the RF signals corresponding to the IMU data, at least some of the RF signals being synchronized with the first ultrasonic transmissions.

According to some examples, the one or more rings may be a single ring that includes the plurality of ultrasonic transmitters. In some examples, the one or more rings may be a plurality of rings, each ring of the plurality of rings including one or more ultrasonic transmitters.

In some examples, the HMD may include a microphone system comprising three or more microphones, a display system, a wireless receiver and an HMD control system. The wireless receiver may be configured to receive radio frequency (RF) signals, at least some of which correspond to inertial measurement unit (IMU) data from an IMU of one or more rings, the one or more rings including the first ring.

According to some examples, the HMD control system may be configured to control the display system to provide extended reality effects. In some examples, the HMD control system may be configured to receive microphone signals from the microphone system, the microphone signals corresponding to ultrasonic transmissions from each of a plurality of ultrasonic transmitters of one or more rings configured to be worn on a human digit. The one or more rings may include the first ring. Each ultrasonic transmitter of the plurality of ultrasonic transmitters may have a different ultrasonic transmission type of a plurality of ultrasonic transmission types. For example, each of the ultrasonic transmission types may correspond to a different code or a different frequency from that of the other ultrasonic transmission types.

According to some examples, the HMD control system may be configured to determine a correspondence between each ultrasonic transmission type and each ultrasonic transmitter. In some examples, the HMD control system may be configured to receive IMU data from the wireless receiver corresponding to received RF signals. According to some examples, the HMD control system may be configured to determine a position and an orientation of the one or more rings based, at least in part, on the microphone signals and the IMU data.

In some examples, the HMD control system may be configured to determine a hand motion or a hand gesture based, at least in part, on microphone signals corresponding to ultrasonic transmissions from the one or more rings.

Other innovative aspects of the subject matter described in this disclosure may be implemented in one or more methods. In some examples, a method may involve controlling, by a ring control system, a first ultrasonic transmitter of a ring ultrasonic transmitter system to produce first ultrasonic transmissions of a first ultrasonic transmission type. According to some examples, a method may involve controlling, by the ring control system, a ring wireless transmitter to transmit RF signals, the RF signals being synchronized with the first ultrasonic transmissions.

Some other innovative aspects of the subject matter described in this disclosure may be implemented in one or more alternative methods. In some examples, a method may involve receiving, by an HMD control system, microphone signals from an HMD microphone system. The microphone signals may correspond to ultrasonic transmissions from each of a plurality of ultrasonic transmitters of one or more rings. Each ultrasonic transmitter of the plurality of ultrasonic transmitters may have a different ultrasonic transmission type of a plurality of ultrasonic transmission types. According to some examples, a method may involve determining, by the HMD control system, a correspondence between each ultrasonic transmission type and each ultrasonic transmitter. In some examples, a method may involve receiving, by the HMD control system, IMU data corresponding to RF signals received from an HMD wireless receiver. According to some examples, a method may involve determining, by the HMD control system, a position and an orientation of the one or more rings based, at least in part, on the microphone signals and the IMU data.

Some or all of the operations, functions or methods described herein may be performed by one or more devices according to instructions (such as software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon. For example, the software may include instructions for controlling one or more devices to perform a method. In some examples, a method may involve controlling, by a ring control system, a first ultrasonic transmitter of a ring ultrasonic transmitter system to produce first ultrasonic transmissions of a first ultrasonic transmission type. According to some examples, a method may involve controlling, by the ring control system, a ring wireless transmitter to transmit RF signals, the RF signals being synchronized with the first ultrasonic transmissions.

Alternatively, or additionally, in some examples a method may involve receiving, by an HMD control system, microphone signals from an HMD microphone system. The microphone signals may correspond to ultrasonic transmissions from each of a plurality of ultrasonic transmitters of one or more rings. Each ultrasonic transmitter of the plurality of ultrasonic transmitters may have a different ultrasonic transmission type of a plurality of ultrasonic transmission types. According to some examples, a method may involve determining, by the HMD control system, a correspondence between each ultrasonic transmission type and each ultrasonic transmitter. In some examples, a method may involve receiving, by the HMD control system, IMU data corresponding to RF signals received from an HMD wireless receiver. According to some examples, a method may involve determining, by the HMD control system, a position and an orientation of the one or more rings based, at least in part, on the microphone signals and the IMU data.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a block diagram that presents example components of an apparatus.

FIG. 2 is a block diagram that presents example components of a head-mounted device (HMD).

FIG. 3 show examples of a system that includes the apparatus of FIG. 1 and the apparatus of FIG. 2.

FIG. 4 is a block diagram that shows additional example components of the apparatus of FIG. 1.

FIGS. 5A, 5B and 5C show examples of the apparatus of FIG. 1.

FIGS. 6A and 6B show different views of another example of the apparatus of FIG. 1.

FIG. 7 shows a cross-sectional view of another example of the apparatus of FIG. 1.

FIGS. 8A, 8B and 8C show additional examples of the apparatus of FIG. 1.

FIGS. 9A, 9B and 9C show additional examples of the apparatus of FIG. 1.

FIGS. 10A and 10B show examples of the apparatus of FIG. 2.

FIG. 11 is a flow diagram that presents examples of operations according to some disclosed methods.

FIG. 12 is a flow diagram that presents examples of operations according to some additional disclosed methods.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, head-mounted devices, including but not limited to XR headsets and XR eyeglass frames, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), mobile health devices, computer monitors, automobile components, including but not limited to automobile displays (such as odometer and speedometer displays, etc.), cockpit controls or displays, camera view displays (such as the display of a rear view camera in a vehicle), electronic photographs, electronic billboards or signs, projectors, architectural structures, microwaves, refrigerators, stereo systems, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A device for indicating hand motions, gestures, etc., for the purpose of interacting with other devices, including but not limited to XR head-mounted devices (HMDs), may be referred to herein as a “hand tracking” device. Providing a hand tracking device, in addition to audio and video effects, can create a relatively more immersive extended XR experience. For example, interacting with a virtual world via a hand tracking device may provide a user with the ability to conceptualize, design, and interact with three-dimensional digital assets, such as virtual shapes, virtual objects, and virtual figures. Previously-deployed hand tracking devices have generally been hand-held controllers. Some previously-deployed hand tracking devices include light-emitting components to indicate a hand position. Such light-based hand tracking devices do not work well, or at all, if the ambient light levels are too high. For example, light-based hand tracking devices are generally not suitable for outdoor use.

In some disclosed implementations, an apparatus or system may be, or may include, one or more instances of a ring that is configured to be worn on a human digit. The ring may include an ultrasonic transmitter system attached to the housing and including one or more ultrasonic transmitters. The ring may include an IMU configured to generate IMU data corresponding to an orientation of the ring. The ring may include a wireless transmitter configured to transmit RF signals. At least some of the RF signals may correspond to the IMU data. The ring may include a control system configured to control a first ultrasonic transmitter of the ultrasonic transmitter system to produce first ultrasonic transmissions of a first ultrasonic transmission type. The ring may include a control system configured to control the wireless transmitter to transmit RF signals, at least some of which include IMU data. The RF signals may be synchronized with the first ultrasonic transmissions. The control system may be configured to control a second ultrasonic transmitter of the ultrasonic transmitter system to produce second ultrasonic transmissions of a second ultrasonic transmission type, the second ultrasonic transmissions being synchronized with the RF signals.

In some examples, an apparatus or system may be, or may include, an HMD such as a headset or an eyeglass frame. According to some examples, the HMD may include a microphone system, a display system and a control system. The microphone system may, in some examples, include three or more microphones. According to some examples, the HMD control system may be configured to control at least the display system to provide extended reality effects. In some examples, the control system may be configured to receive microphone signals from the microphone system. In some instances, the microphone signals may correspond to ultrasonic transmissions from each of a plurality of ultrasonic transmitters of one or more rings configured to be worn on a human digit. According to some examples, each transmitter of the plurality of ultrasonic transmitters may have a different ultrasonic transmission type. In some examples, the HMD control system may be configured to determine a correspondence between each ultrasonic transmission type and each ultrasonic transmitter. According to some examples, the HMD control system may be configured to determine a position and an orientation of the one or more rings based, at least in part, on the microphone signals. In some examples, the HMD may include a wireless receiver that is configured to receive RF signals, at least some of which include IMU data from the one or more rings. The RF signals may be synchronized with the first ultrasonic transmissions. According to some examples, the HMD control system may be configured to determine a position and an orientation of the one or more rings based, at least in part, on the microphone signals and the IMU data.

Particular implementations of the subject matter described in this disclosure may be implemented to realize one or more of the following potential advantages. In some implementations, an ultrasound-based hand tracking system may include one or more rings are smaller than and lighter than prior hand-held hand tracking devices provided for use with, or deployed as part of, an XR system. Moreover, the disclosed ultrasound-based ring-type hand tracking devices are also suitable for outdoor use and for indoor use when ambient light levels are high, unlike previously-deployed light-based hand tracking devices. The disclosed ultrasound-based ring-type hand tracking devices may also consume less power than previously-deployed hand tracking devices. The disclosed ultrasound-based ring-type hand tracking devices may also have a lower bill of materials (BOM) cost, as compared to previously-deployed hand tracking devices.

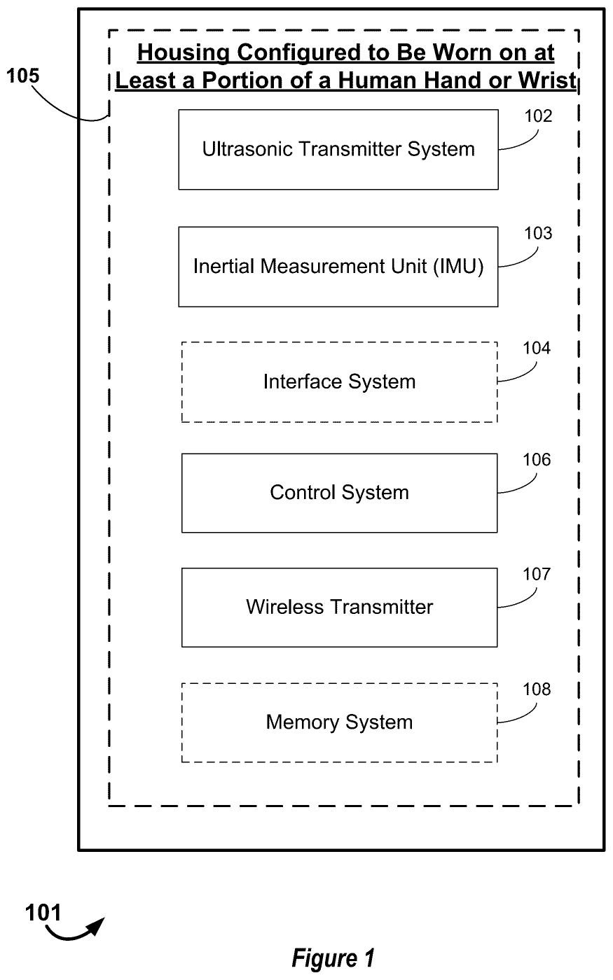

FIG. 1 is a block diagram that presents example components of an apparatus. In this example, the apparatus 101 includes a housing 105 that is configured to be worn on at least a portion of a human hand or wrist, an ultrasonic transmitter system 102, an internal measurement unit (IMU) 103, a control system 106 and a wireless transmitter 107. The numbers, types and arrangements of elements shown in the figures provided herein, including but not limited to FIG. 1, are merely examples. Other examples may include different elements, different arrangements of elements, or combinations thereof. Some implementations may include an interface system 104, a memory system 108, or combinations thereof. The optional memory system 108—when present—may be separate from, but configured for communication with, the control system 106.

In this example, the ultrasonic transmitter system 102, the IMU 103, the interface system 104, the control system 106, the wireless transmitter 107 and the optional memory system 108 are shown as being within a dashed rectangle that represents the housing 105, indicating that these components are part of the housing 105, mounted on the housing 105, reside within the housing 105, or combinations thereof. In some examples, the housing 105 may be, or may include, a ring that is configured to be worn on a human digit. Alternatively, or additionally, the housing 105 may be, or may include, a watch, a bracelet, a glove or portion thereof, a band configured to be worn on a human palm, etc. Some implementations may include multiple instances of the housing 105, e.g., multiple rings. Various examples of ring versions of the apparatus 101 are provided in this disclosure.

The ultrasonic transmitter system 102 may include one or more ultrasonic transmitters. In some examples, the ultrasonic transmitter system 102 may include one or more instances, or arrays, of ultrasonic transducer elements that are that are configured to convert electrical signals into ultrasound. In some examples, the ultrasonic transmitter system 102 may include one or more piezoelectric micromachined ultrasonic transducers (PMUTs), one or more capacitive micromachined ultrasonic transducers (CMUTs), etc. According to some examples, the ultrasonic transmitter system 102 may include one or more piezoelectric layers, such as one or more layers of polyvinylidene fluoride PVDF polymer, polyvinylidene fluoride-trifluoroethylene (PVDF-TrFE) copolymer, scandium-doped aluminum nitride (ScAlN), or a combination thereof. In some examples, the one or more piezoelectric layers may extend partially or completely around a ring version of the apparatus 101.

The IMU 103 may be configured to detect the acceleration, rotation, rotational rate, orientation, etc., of the apparatus 101. The IMU 103 may, for example, include one or more gyroscopes and one or more accelerometers. According to some examples, the IMU 103 may include one or more magnetometers. In some examples, the IMU 103 may include multiple gyroscopes and multiple accelerometers, e.g., one accelerometer and gyroscope per axis for each of three orthogonal axes, in order to measure pitch, roll and yaw. In some such examples, the IMU 103 may include a magnetometer for each of the three orthogonal axes.

The interface system 104 may be configured to provide communication (which may include wired or wireless communication, electrical communication, radio communication, etc.) between components of the apparatus 101. In some examples, the interface system 104 may be configured to provide communication between the control system 106 and the ultrasonic transmitter system 102 and between the control system 106 and the IMU 103. According to some such examples, the interface system 104 may couple at least a portion of the control system 106 to the ultrasonic transmitter system 102 and the interface system 104 may couple at least a portion of the control system 106 to the IMU 103, such as via electrically conducting material (for example, via conductive metal wires or traces). In some examples, the interface system 104 may be configured to provide communication between the apparatus 101 and a human being. In some such examples, the interface system 104 may include one or more user interfaces. In some examples, the user interface(s) may be provided via a touch sensor system, a display system, a microphone system 112, a gesture sensor system, or combinations thereof. The interface system 104 may, in some examples, include one or more network interfaces or one or more external device interfaces (such as one or more universal serial bus (USB) interfaces or a serial peripheral interface (SPI)).

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc. According to some examples, the control system 106 may include one or more dedicated components for controlling the ultrasonic transmitter system 102, the wireless transmitter 107, etc.

The wireless transmitter 107 may be configured to transmit radio frequency (RF) signals according to instructions from the control system 106. According to some examples, the wireless transmitter 107 may be configured to transmit RF signals corresponding to IMU data from the IMU 103.

In this example, the control system 106 is configured for communication with, and configured for controlling, the ultrasonic transmitter system 102 and the wireless transmitter 107. According to some examples, the control system 106 may be configured for controlling the wireless transmitter 107 to transmit RF signals. At least some of the RF signals may corresponding to, or include, IMU data from the IMU 103. In some examples, the control system 106 may be configured for synchronizing wireless transmissions of the wireless transmitter 107—which may include, but which are not limited to RF signals corresponding to IMU data—with ultrasonic transmissions from the ultrasonic transmitter system 102.

According to some examples, the control system 106 may be configured for controlling a first ultrasonic transmitter of the ultrasonic transmitter system 102 to produce first ultrasonic transmissions of a first ultrasonic transmission type. In some such examples, some examples, the control system 106 may be configured for controlling a second ultrasonic transmitter of the ultrasonic transmitter system 102 to produce second ultrasonic transmissions of a second ultrasonic transmission type. According to some examples, the first ultrasonic transmission type may correspond to a first code and the second ultrasonic transmission type may correspond to a second code. In some examples, the first ultrasonic transmission type may correspond to a first frequency and the second ultrasonic transmission type may correspond to a second frequency. According to some examples, the control system 106 may be configured for controlling N ultrasonic transmitters of the ultrasonic transmitter system 102 to produce ultrasonic transmissions of N different ultrasonic transmission types.

In some examples, the memory system 108 may include one or more memory devices, such as one or more RAM devices, ROM devices, etc. In some implementations, the memory system 108 may include one or more computer-readable media, storage media or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

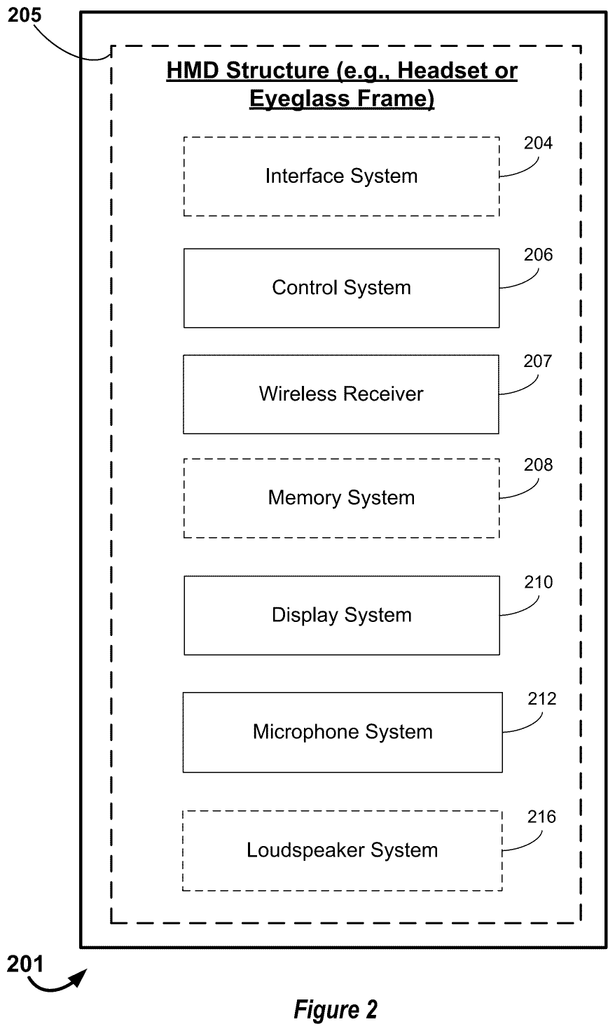

FIG. 2 is a block diagram that presents example components of a head-mounted device (HMD). In this example, the HMD 201 includes an HMD structure 205, a control system 206, a wireless receiver 207, a display system 210 and a microphone system 212. The numbers, types and arrangements of elements shown in the figures provided herein, including but not limited to FIG. 2, are merely examples. Other examples may include different elements, different arrangements of elements, or combinations thereof. Some implementations may include an interface system 204, a memory system 208, a loudspeaker system 216, or combinations thereof. In this example, the ultrasound-based haptic system 102, the control system 206 and the optional interface system 204, control system 206, wireless receiver 207, optional memory system 208, display system 210, microphone system 212 and optional loudspeaker system 216 are shown as being within a dashed rectangle that represents the HMD structure 205, indicating that these components are part of the HMD structure 205, mounted on the HMD structure 205, reside within the HMD structure 205, or combinations thereof. In some examples, the HMD structure 205 may be, or may include, a headset or an eyeglass frame.

Some implementations of the HMD 201 may include an interface system 204. In some implementations, the interface system 204 may include a user interface system, one or more network interfaces, one or more interfaces between the HMD 201 and one or more other devices, or combinations thereof. In some examples, the user interface system may include a touch sensor system, the display system 210, the microphone system 212, a gesture sensor system, or combinations thereof. The interface system 204 may, in some examples, include one or more external device interfaces (such as one or more universal serial bus (USB) interfaces or a serial peripheral interface (SPI)).

The interface system 204 may be configured to provide communication (which may include wired or wireless communication, electrical communication, radio communication, etc.) between components of the HMD 201. The interface system 204 may be configured to provide one or more interfaces between the control system 206 and the wireless receiver 207, one or more interfaces between the control system 206 and the memory system 208, one or more interfaces between the control system 206 and the display system 210, one or more interfaces between the control system 206 and the microphone system 212, one or more interfaces between the control system 206 and the loudspeaker system 216, one or more interfaces between the control system 206 and one or more external device interfaces (such as ports or applications processors), or combinations thereof. According to some such examples, the interface system 204 may electrically couple at least a portion of the control system 206 to one or more other elements of the HMD 201, such as via electrically conducting material (for example, via conductive metal wires or traces).

The control system 206 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 206 also may include one or more memory devices, such as one or more random access memory (RAM) devices, read-only memory (ROM) devices, etc.

In this example, the control system 206 is configured for communication with, and configured for controlling, elements of the HMD structure 205 to provide XR effects. The XR effects may include visual effects provided by the display system 210, audio effects provided by the optional loudspeaker system 216, or combinations thereof. For example, the HMD structure 205 may be an XR headset and the control system 206 may be configured for controlling elements of the XR headset to provide XR effects. In other examples, the HMD structure 205 may be an eyeglass frame and the control system 206 may be configured for controlling elements of the eyeglass frame to provide XR effects.

According to some examples, the control system 206 may be configured to receive microphone signals from the microphone system 212. The microphone signals may correspond to ultrasonic transmissions from each of a plurality of ultrasonic transmitters of a housing configured to be worn on at least a portion of a human hand or wrist. In some examples, the housing may be, or may include, one or more rings configured to be worn on one or more human digits. According to some examples, each ultrasonic transmitter of the plurality of ultrasonic transmitters may have a different ultrasonic transmission type of a plurality of ultrasonic transmission types.

In some examples, the control system 206 may be configured to determine a correspondence between each ultrasonic transmission type and each ultrasonic transmitter.

According to some examples, the control system 206 may be configured to determine a position and an orientation of the housing—for example, of the one or more rings—based, at least in part, on the microphone signals.

According to some examples, the control system 206 may be configured to receive IMU data included with RF signals received by the wireless receiver 207. In some examples, the control system 206 may be configured to determine the position and the orientation of the housing—for example, of the one or more rings—based, at least in part, on the IMU data.

In implementations where the apparatus includes a memory system 208 that is separate from the control system 206, the control system 206 also may be configured for communication with the memory system 208. According to some examples, the control system 206 may include one or more dedicated components for controlling the memory system 208, the display system 210, the microphone system 212 and/or the loudspeaker system 216. In some implementations, functionality of the control system 206 may be partitioned between one or more controllers or processors, such as between a dedicated display controller and an applications processor.

In some examples, the memory system 208 may include one or more memory devices, such as one or more RAM devices, ROM devices, etc. In some implementations, the memory system 208 may include one or more computer-readable media, storage media or storage media. Computer-readable media include both computer storage media and communication media including any medium that may be enabled to transfer a computer program from one place to another. Storage media may be any available media that may be accessed by a computer. In some examples, the memory system 208 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

In some examples, the HMD 201 may include a display system 210 having one or more displays. In some examples, the display system 210 may be, or may include, a light-emitting diode (LED) display, such as an organic light-emitting diode (OLED) display. In some such examples, the display system 210 may include layers, which may be referred to collectively as a “display stack.”

In this implementation, the HMD 201 includes a microphone system 212. The microphone system 212 may include one or more microphones. According to some examples, the microphone system 212 may include three or more microphones in a front-facing part of the HMD structure 205. In some examples, the microphone system 212 may include one or more additional microphones on side portions of the HMD structure 205, such as on temples of an eyeglass frame.

In some implementations, the HMD 201 may include a loudspeaker system 216. The loudspeaker system 216 may be, or may include, one or more loudspeakers or groups of loudspeakers. In some examples, the loudspeaker system 216 may include one or more loudspeakers, or one or more groups of loudspeakers, corresponding to a left ear and one or more loudspeakers, or one or more groups of loudspeakers, corresponding to a right ear. In some implementations, at least a portion of the loudspeaker system 216 may reside within an earcup, an earbud, etc. In some examples, at least a portion of the loudspeaker system 216 may reside in or on a portion of an eyeglass frame that is intended to reside near a wearer's ear or that is intended to touch the wearer's ear.

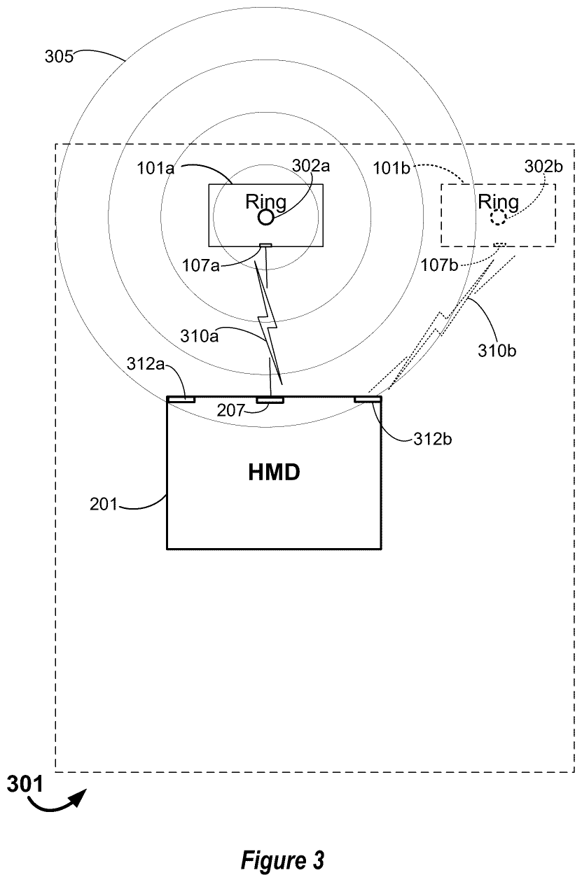

FIG. 3 show examples of a system that includes the apparatus of FIG. 1 and the apparatus of FIG. 2. The numbers, types and arrangements of elements shown in the figures provided herein, including but not limited to FIG. 3, are merely examples. Other examples may include different elements, different arrangements of elements, or combinations thereof.

According to this example, the system 301 includes at least one instance of the apparatus 101 of FIG. 1—in this instance, at least the apparatus 101a and optionally the apparatus 101b—in communication with an instance of the apparatus 201 of FIG. 2. In this example, the apparatus 101a and the optional apparatus 101b are rings and are instances of the apparatus 101. According to this example, the apparatus 201 is an HMD. Accordingly, FIG. 3 is not drawn to scale. In some examples, the apparatus 101a and the apparatus 101b may be physically coupled to one another. Some examples are provided in this disclosure.

In this example, at least one instance of the apparatus of FIG. 1 is in communication with the apparatus of FIG. 2. Here, the apparatus 101a includes a wireless transmitter 107a and at least the ultrasonic transmitter 302a, and the optional apparatus 101b includes a wireless transmitter 107b and at least the ultrasonic transmitter 302b. According to this example, the ultrasonic transmitter 302a is transmitting ultrasonic waves 305, which are being detected by the microphones 312a and 312b of the apparatus 201. In some implementations, the apparatus 201 may include one or more additional microphones that are not visible in FIG. 3. According to some examples, a control system 206 of the apparatus 201—which is not shown in FIG. 3—may be configured to determine the position of the apparatus 101a based, at least on part, on microphone signals from microphones of the apparatus 201, including but not necessarily limited to the microphones 312a and 312b. In some such examples, the control system 206 may be configured to determine the position of the apparatus 101a based, at least on part, on a triangulation process that involves the microphone signals.

According to this example, the wireless transmitter 107a is transmitting RF signals 310a to the wireless receiver 207, which is configured to receive the RF signals 310a. In this example, the RF signals 310a are synchronized with the ultrasonic waves 305. For example, a control system 106 of the apparatus 101a—which is not shown in FIG. 3—may be configured to control the wireless transmitter 107a to transmit RF signals 310a at the same time that the ultrasonic transmitter 302a begins to transmit a pulse of ultrasonic waves 305. According to some examples, an IMU 103 of the apparatus 101a—which is not shown in FIG. 3—may generate IMU data and a control system 106 of the apparatus 101a may be configured to control the wireless transmitter 107a to transmit RF signals 310a corresponding to the IMU data. In some such examples, the control system 206 may be configured to determine an orientation of the apparatus 101a based, at least on part, on RF signals 310a corresponding to the IMU data that are received by the wireless receiver 207.

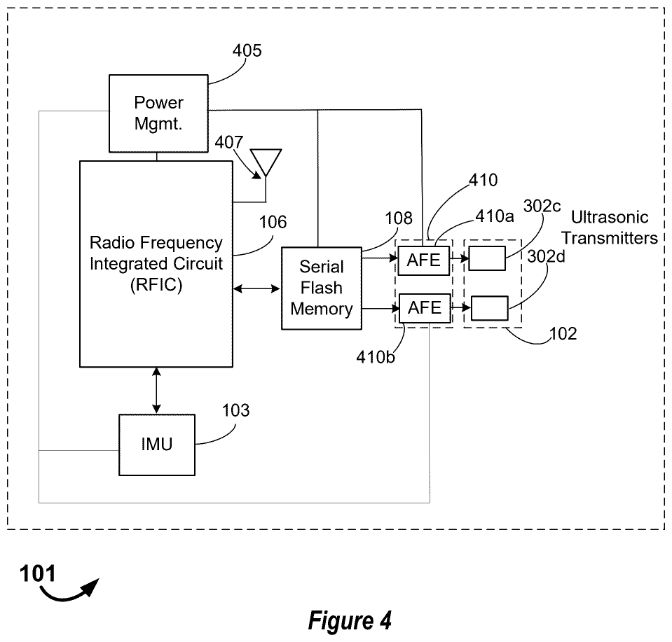

FIG. 4 is a block diagram that shows additional example components of the apparatus of FIG. 1. In this example, the apparatus 101 includes an ultrasonic transmitter system 102, including ultrasonic transmitters 302c and 302d, an IMU 103, a control system 106, a wireless transmitter 107, a memory system 108, which includes a serial flash memory in this instance, a power management system 405, and an analog front end (AFE) system 410, including AFE controllers 410a and 410b. The numbers, types and arrangements of elements shown in the figures provided herein, including but not limited to FIG. 4, are merely examples. Other examples may include different elements, different arrangements of elements, or combinations thereof. Although not shown in FIG. 4, the apparatus 101 may include a housing 105 that is configured to be worn on at least a portion of a human hand or wrist, such as a ring that is configured to be worn on a human digit.

In this example, the control system 106 is, or includes, a radio frequency integrated circuit (RFIC) that is configured for operating in a frequency range suitable for wireless transmission. According to this example, the wireless transmitter 107 is integrated with the RFIC. In some examples, the wireless transmitter 107 may be a wireless transceiver that is operated by the RFIC in a transmit mode.

According to this example, the power management system 405 provides power to the IMU 103, the control system 106, the AFE system 410, and potentially to other components of the apparatus 101, as needed. The power management system 405 may include one or more batteries. The power management system 405 may be configured for wireless charging or wired charging, depending on the particular implementation.

In this example, the control system 106 is configured for communication with the IMU 103 and is configured to receive IMU data from the IMU 103 and to transmit the IMU data via the wireless transmitter 107. In this example, the control system 106 is configured for communication with the ultrasonic transmitter system 102 via the memory system 108 and the AFE system 410. In some implementations, the control system 106 may be configured to communicate directly with the AFE system 410, without communicating via the memory system 108. For example, the control system 106 may be configured to read data from the memory system 108 and send the data to the AFE system 410. Whether communicating directly with the AFE system 410 or indirectly via the memory system 108, the control system 106 may provide control signaling to enable or disable the AFE controllers 410a and 410b, to set gains, to set other parameters, etc.

According to some examples, the control system 106 may be configured for synchronizing wireless transmissions of the wireless transmitter 107—which may include, but which are not limited to RF signals corresponding to IMU data—with ultrasonic transmissions from the ultrasonic transmitter system 102.

According to some examples, the control system 106 may be configured for controlling the ultrasonic transmitter 302c to produce first ultrasonic transmissions of a first ultrasonic transmission type. In some such examples, some examples, the control system 106 may be configured for controlling a the ultrasonic transmitter 302d to produce second ultrasonic transmissions of a second ultrasonic transmission type. According to some examples, the first ultrasonic transmission type may correspond to a first code and the second ultrasonic transmission type may correspond to a second code. In some examples, the first ultrasonic transmission type may correspond to a first frequency and the second ultrasonic transmission type may correspond to a second frequency. In some alternative implementations, ultrasonic transmitter system 102 may include N ultrasonic transmitters, where N is a number greater than 2 in this example. According to some such examples, the control system 106 may be configured for controlling N ultrasonic transmitters of the ultrasonic transmitter system 102 to produce ultrasonic transmissions of N different ultrasonic transmission types.

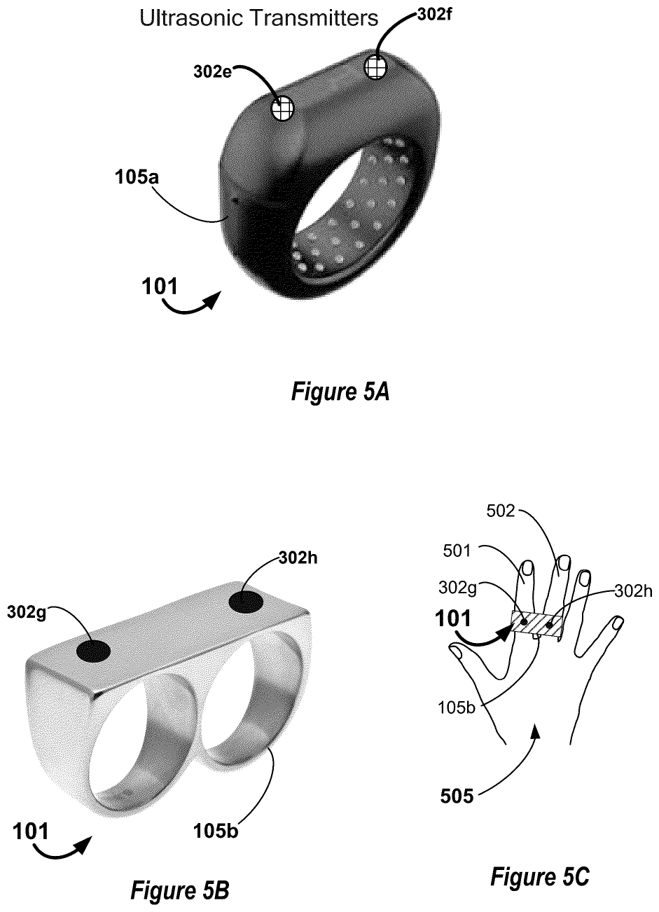

FIGS. 5A, 5B and 5C show examples of the apparatus of FIG. 1. In these examples, the apparatus 101 includes one or more rings that are configured to be worn on one or more human digits. The numbers, types and arrangements of elements shown in FIGS. 5A-5C are merely examples. Other examples may include different elements, different arrangements of elements, or combinations thereof. Although not shown in FIGS. 5A-5C, these examples of apparatus 101 may include an IMU 103, a control system 106, a wireless transmitter 107, a memory system 108, other components, or combinations thereof.

In the example shown in FIG. 5A, the apparatus 101 is a ring having a housing 105a that is configured to be worn on a single human digit. According to this example, the apparatus 101 includes ultrasonic transmitters 302e and 302f of an ultrasonic transmitter system. The ultrasonic transmitters 302e and 302f may, for example, be MEMS-based ultrasonic transmitters.

According to the example shown in FIG. 5B, the apparatus 101 has a housing 105b that includes two rings, each of which is configured to be worn on a human digit. According to this example, the apparatus 101 includes ultrasonic transmitters 302g and 302h of an ultrasonic transmitter system. The ultrasonic transmitters 302g and 302h may, for example, be MEMS-based ultrasonic transmitters.

In the example shown in FIG. 5C, the apparatus 101 of FIG. 5B is shown being worn on fingers of a human hand 505. According to this example, the apparatus 101 is being worn on an index finger 501 and a middle finger 502, such that the ultrasonic transmitters 302g and 302h are positioned over the index finger 501 and the middle finger 502, respectively. In other examples, the apparatus 101 may be worn on other fingers.

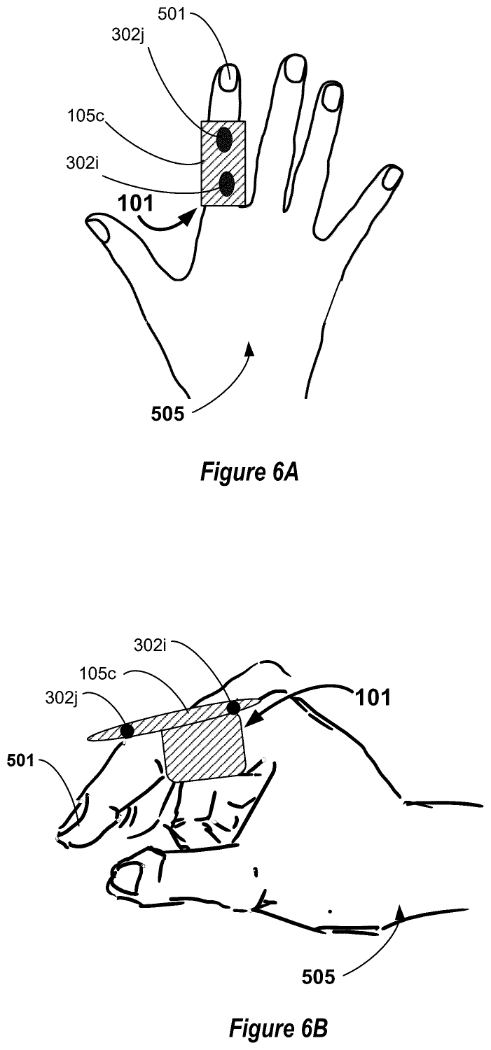

FIGS. 6A and 6B show different views of another example of the apparatus of FIG. 1. The numbers, types and arrangements of elements shown in FIGS. 6A and 6B are merely examples. Other examples may include different elements, different arrangements of elements, or combinations thereof. Although not shown in FIGS. 6A and 6B, these examples of apparatus 101 may include an IMU 103, a control system 106, a wireless transmitter 107, a memory system 108, other components, or combinations thereof.

In the examples shown in FIGS. 6A and 6B, the apparatus 101 is a ring having a housing 105c that is configured to be worn on a single human digit. According to these examples, the apparatus 101 includes ultrasonic transmitters 302i and 302j of an ultrasonic transmitter system. The ultrasonic transmitters 302i and 302j may, for example, be MEMS-based ultrasonic transmitters.

In the examples shown in FIGS. 6A and 6B, the apparatus 101 is shown being worn on an index finger 501, such that the ultrasonic transmitters 302g and 302h are positioned over different portions of the index finger 501. In other examples, the apparatus 101 may be worn on other fingers. FIG. 6A shows an example in which the index finger 501 is being held relatively straight, whereas FIG. 6B shows an example in which the index finger 501 is being bent slightly. One may observe that when the index finger 501 is being bent forward, as shown in FIG. 6B, the ultrasonic transmitter 302j may change position relatively more than the ultrasonic transmitter 302i.

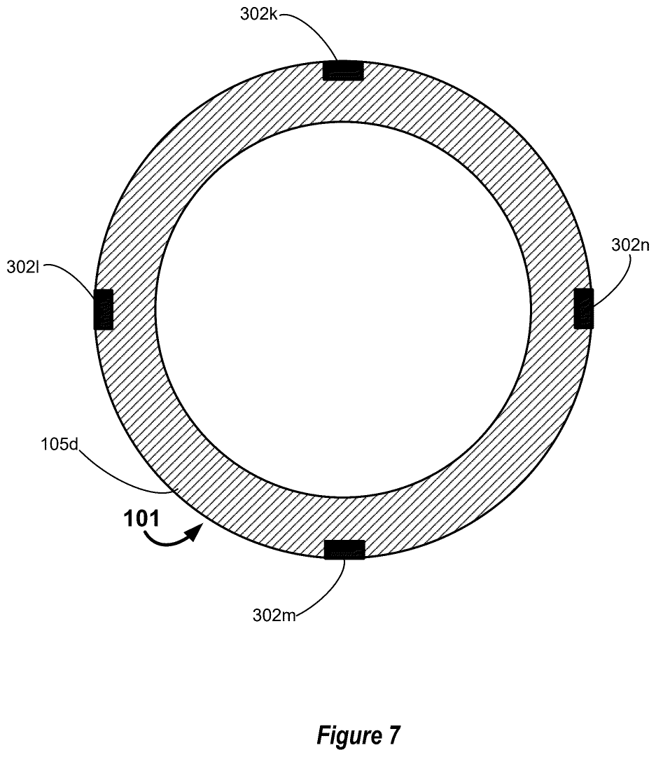

FIG. 7 shows a cross-sectional view of another example of the apparatus of FIG. 1. The numbers, types and arrangements of elements shown in FIG. 7 are merely examples. Other examples may include different elements, different arrangements of elements, or combinations thereof. Although not shown in FIG. 7, the apparatus 101 may include an IMU 103, a control system 106, a wireless transmitter 107, a memory system 108, other components, or combinations thereof.

In the example shown in FIG. 7, the apparatus 101 is a ring having a housing 105d that is configured to be worn on a single human digit. According to this example, the apparatus 101 includes ultrasonic transmitters 302k, 302l, 302m and 302n of an ultrasonic transmitter system. The ultrasonic transmitters 302k-302n may, for example, be MEMS-based ultrasonic transmitters. According to the example shown in FIG. 7, the ultrasonic transmitters 302k-302n are each separated from the closest other ultrasonic transmitters by approximately 90 degrees of the circumference of the housing 105d. This is a potentially advantageous implementation, in that the ultrasonic waves transmitted by the ultrasonic transmitters 302k-302n may be evenly spaced and may be transmitted in all directions in the plane of the housing 105d.

However, in some examples, an adjacent finger may block the transmission from one of the ultrasonic transmitters 302k-302n. Accordingly, some alternative implementations may include only three of the ultrasonic transmitters 302k-302n, e.g., only the ultrasonic transmitters 302k, 302l and 302m. In some alternative examples, the three ultrasonic transmitters may each be separated from the closest other ultrasonic transmitters by approximately 120 degrees of the circumference of the housing 105d.

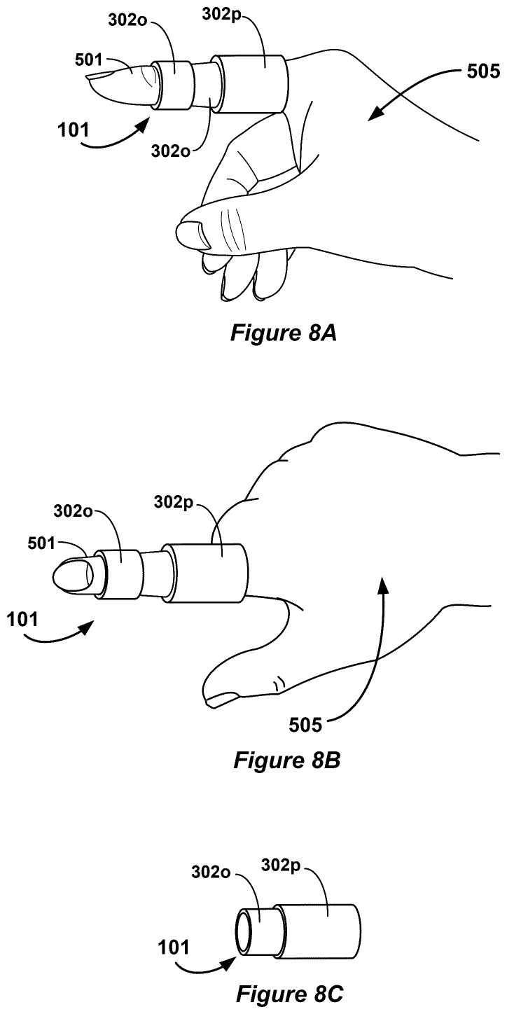

FIGS. 8A, 8B and 8C show additional examples of the apparatus of FIG. 1. The numbers, types and arrangements of elements shown in FIGS. 8A-8C are merely examples.

Other examples may include different elements, different arrangements of elements, or combinations thereof. Although not shown in FIGS. 8A-8C, these examples of apparatus 101 may include an IMU 103, a control system 108, a wireless transmitter 107, a memory system 108, other components, or combinations thereof.

In the examples shown in FIGS. 8A-8C, the apparatus 101 includes two rings that are configured to be worn on a single human digit. According to these examples, the apparatus 101 includes ring-shaped ultrasonic transmitters 302o and 302p of an ultrasonic transmitter system. In these examples, the ultrasonic transmitters 302o and 302p include one or more types of piezoelectric material, such as PVDF, in ring configurations.

In the examples shown in FIGS. 8A and 8B, the apparatus 101 is shown being worn on an index finger 501, such that the ultrasonic transmitters 302o and 302p are positioned over different portions of the index finger 501. FIG. 8A shows an example of a top view and FIG. 8B shows an example of a side view. In other examples, the apparatus 101 may be worn on other fingers. According to the examples shown in FIGS. 8A and 8B, the apparatus 101 includes a flexible portion 805 between the ultrasonic transmitters 302o and 302p. In these examples, the flexible portion 805 structurally connects the ultrasonic transmitters 302o and 302p. According to some examples, the flexible portion 805 may include embedded circuitry that is electrically connected to the ultrasonic transmitters 302o and 302p. For example, the flexible portion 805 may be, or may include, flexible printed circuit board (PCB) material.

In the example shown in FIG. 8C, the apparatus 101 also includes ring-shaped ultrasonic transmitters 302o and 302p. However, in this example, the apparatus 101 does not include the flexible portion 805.

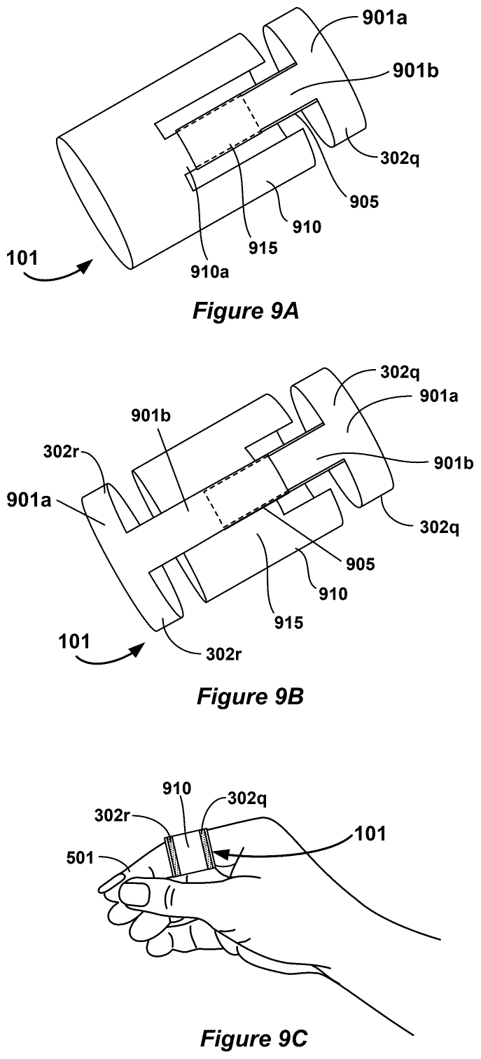

Implementations of the apparatus 101 such as shown in FIGS. 8A and 8B have potential advantages over implementations such as shown in FIGS. 6A, 6B and 9C, because the flexible portion 805 may allow a wearer to bend the apparatus 101 into a variety of different positions. These positions may allow tracking of a relatively greater number of hand and finger positions, including hand and finger positions that involve bent or curled fingers, when using the apparatus 101 of FIGS. 8A and 8B. Accordingly, such implementations may allow the apparatus 101 to convey a relatively larger variety of commands, instructions, etc., to another device (e.g., to an HMD).

FIGS. 9A, 9B and 9C show additional examples of the apparatus of FIG. 1. The numbers, types and arrangements of elements shown in FIGS. 9A-9C are merely examples.

Other examples may include different elements, different arrangements of elements, or combinations thereof. Although not shown in FIGS. 9A-9C, these examples of apparatus 101 may include an IMU 103, a control system 109, a wireless transmitter 107, a memory system 109, other components, or combinations thereof.

In the examples shown in FIGS. 9A-9C, the apparatus 101 includes at least one ring that is configured to be worn on a human digit. According to these examples, the apparatus 101 includes at least the ultrasonic transmitter 302q, which may also be referred to as ultrasonic transducer 302q, of an ultrasonic transmitter system. In the examples shown in FIGS. 9B and 9C, the apparatus 101 also includes the ultrasonic transmitter 302r, which may also be referred to as ultrasonic transducer 302r. In these examples, the ultrasonic transmitters 302q and 302r include one or more types of piezoelectric material, such as PVDF.

According to the examples shown in FIGS. 9A and 9B, the ultrasonic transducers 302q and 302r each have a ring-shaped portion 901a that is configured to extend at least partially around a wearer's finger and an extension 901b that is configured to extend along at least a portion of the wearer's finger, inside a transducer groove 905 in these examples. In these examples, the extensions 901b are configured to extend over, and to make electrical contact with, a portion of a flexible PCB 910. In the examples shown in FIGS. 9A and 9B, a contact 915 secures one or both of the extensions 901b to the portion of the flexible PCB 910. The contact 915 may, for example, be an adhesive material or include an adhesive material.

In the example shown in FIG. 9C, the apparatus 101 of FIG. 9B is shown being worn on an index finger 501, such that the ultrasonic transmitters 302q and 302r are positioned over different portions of the index finger 501.

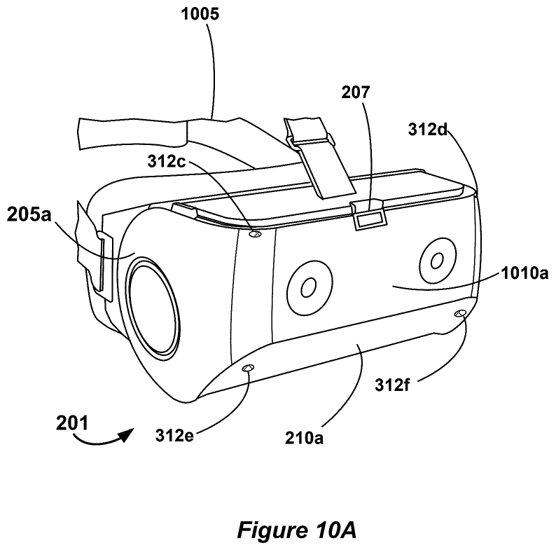

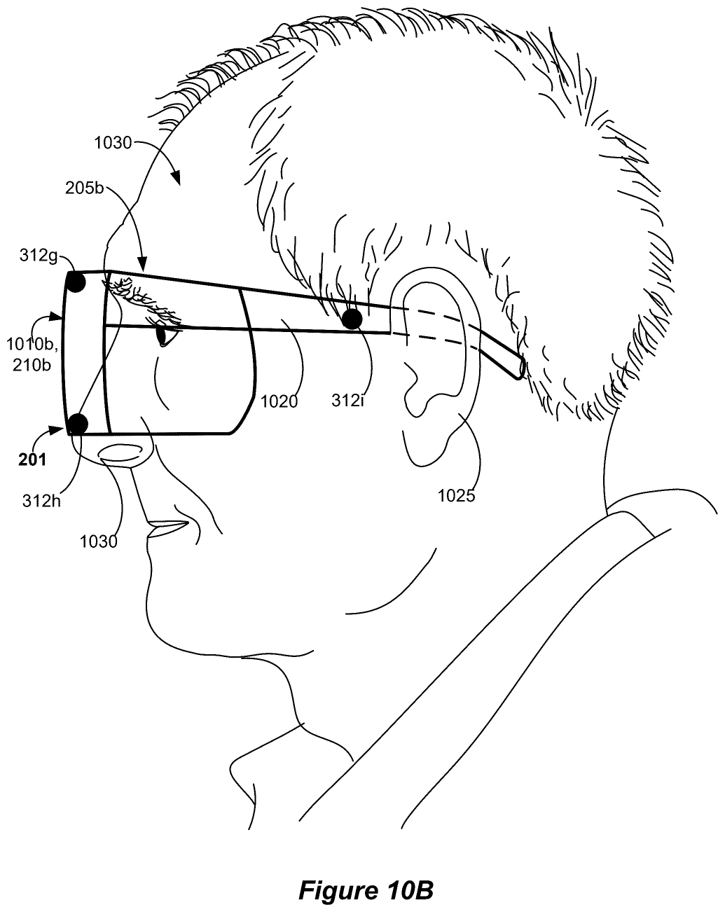

FIGS. 10A and 10B show examples of the apparatus of FIG. 2. The numbers, types and arrangements of elements shown in FIGS. 10A and 10B are merely examples. Other examples may include different elements, different arrangements of elements, or combinations thereof. Although not shown in FIGS. 10A and 10B, these examples of apparatus 201 include at least a control system 206 and may include an interface system 204, a memory system 108, a loudspeaker system 216, other components, or combinations thereof.

In the examples shown in FIGS. 10A and 10B, the apparatus 201 is an HMD that is configured to be worn on a human head. According to the example shown in FIG. 10A, the apparatus 201 has an HMD structure 205a, which is that of a headset, and includes a strap 1005 for securing the HMD structure 205a to a person's head. In this example, the surface 1010a is a front-facing surface, behind which a display system 210a resides.

According to the example shown in FIG. 10A, the apparatus 201 includes microphones 312c, 312d, 312e and 312f of a microphone system 212. FIG. 10A also shows that the apparatus 201 includes a wireless receiver 207, which may be a wireless transceiver in some instances.

In the example shown in FIG. 10B, the apparatus 201 is shown being worn on a person's head 1030. In this example, the apparatus 201 has an HMD structure 205b, which is an eyeglass structure in this example. A front portion of the HMD structure 205b is configured to rest on the person's nose 1030 and temples 1020 of the HMD structure 205b are configured to extend behind the person's ears 1025, thereby securing the HMD structure 205b to the person's head 1030. In this example, the surface 1010b is a front-facing surface, behind which a display system 210b resides.

According to the example shown in FIG. 10B, the apparatus 201 includes microphones 312g, 312h and 312i of a microphone system 212, as well as corresponding microphones on an opposing side of the apparatus 201 that is not visible in FIG. 10B. The apparatus 201 FIG. 10A also includes a wireless receiver 207, which is not visible in FIG. 10B.

The microphones 312c-312i—as well as the other microphones that are not visible in FIG. 10—may be any suitable type of microphones. In some examples, the microphones may be, or may include, directional microphones such as cardioid microphones, supercardioid microphones, hypercardioid microphones, etc.

In the examples shown in FIGS. 10A and 10B, the control systems 206s are configured for communication with, and configured for controlling, elements of the HMD structures 205a and 205b to provide XR effects. The XR effects may include visual effects provided by the display systems 210a and 210b, audio effects provided by the optional loudspeaker system 216, or combinations thereof.

According to these examples, the control systems 206 are configured to receive microphone signals from the microphone systems 212. The microphone signals may correspond to ultrasonic transmissions from each of a plurality of ultrasonic transmitters of a housing configured to be worn on at least a portion of a human hand or wrist. In some examples, the housing may be, or may include, one or more rings configured to be worn on a human digit. According to some examples, each ultrasonic transmitter of the plurality of ultrasonic transmitters may have a different ultrasonic transmission type of a plurality of ultrasonic transmission types.

In some examples, the control systems 206 may be configured to determine a correspondence between each ultrasonic transmission type and each ultrasonic transmitter. According to some examples, the control systems 206 may be configured to determine a position and an orientation of the housing—for example, of the one or more rings—based, at least in part, on the microphone signals. Determining the position and the orientation of the one or more rings may involve a triangulation process that is based, at least in part, on the microphone signals. According to some examples, the control systems 206 may be configured to receive IMU data corresponding to RF signals received by the wireless receivers 207. In some examples, the control systems 206 may be configured to determine the position and the orientation of the housing—for example, of the one or more rings—based, at least in part, on the IMU data.

In some examples, the control systems 206 may be configured to determine a hand motion, a hand gesture, or both, based at least in part on microphone signals corresponding to ultrasonic transmissions from one or more rings, based at least in part on IMU data received from the one or more rings, or both. The hand motion and/or hand gesture may, in some instances, correspond to a command for controlling some aspect the HMD's functionality. In some instances, the hand motion and/or hand gesture may involve an interaction between a user's hand, on which the one or more rings are being worn, and a virtual object that is being presented by a display system of the HMD.

For example, even if a user is wearing a single ring having a single ultrasonic transmitter, simple up and down hand motions, back and forth hand motions, lateral hand motions, circular hand motions, etc., may be detected. If a user is wearing a multiple rings, more complex motions and hand gestures may be detected. For example, if a user is wearing one ring on a thumb and at least one other ring on a finger, such as an index finger, a pinching motion, a squeezing motion, etc., may be detected. Accordingly, multiple-ring use cases may provide for more complex control signals and/or interactions with virtual objects.

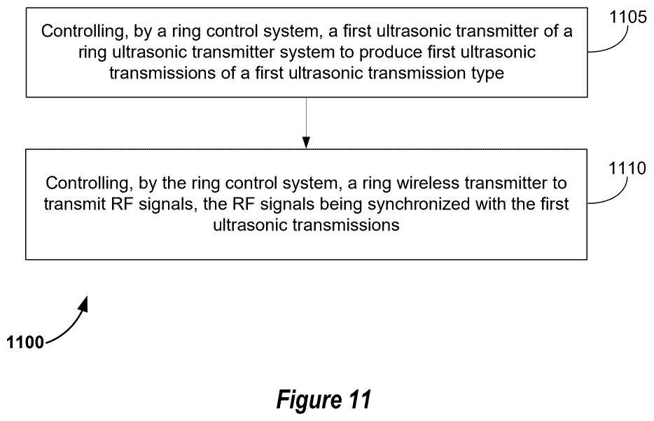

FIG. 11 is a flow diagram that presents examples of operations according to some disclosed methods. The blocks of FIG. 11 may, for example, be performed by the apparatus 101 of FIG. 1, by the apparatus 101 of any one of FIGS. 3-9C, or by a similar apparatus. For example, in some instances method 1100 may be performed, at least in part, by the control system 106 of FIG. 1. As with other methods disclosed herein, the methods outlined in FIG. 11 may include more or fewer blocks than indicated. Moreover, the blocks of methods disclosed herein are not necessarily performed in the order indicated. In some implementations, one or more blocks may be performed concurrently.

In this example, method 1100 is performed by an apparatus that is, or includes, a ring that is configured to be worn on a human digit. According to this example, block 1105 involves controlling, by a ring control system, a first ultrasonic transmitter of a ring ultrasonic transmitter system to produce first ultrasonic transmissions of a first ultrasonic transmission type. In this example, block 1110 involves controlling, by the ring control system, a ring wireless transmitter to transmit RF signals. According to this example, the RF signals are synchronized with the first ultrasonic transmissions. In some examples, an apparatus that is performing the method 1100 may include an inertial measurement unit (IMU) that is configured to generate IMU data corresponding to an orientation of the apparatus. According to some such examples, at least some of the transmitted RF signals may correspond to, or may include, the IMU data.

In some examples, method 1100 may involve controlling, by the ring control system, a second ultrasonic transmitter of the ultrasonic transmitter system to produce second ultrasonic transmissions of a second ultrasonic transmission type. The second ultrasonic transmissions may also be synchronized with the RF signals. According to some examples, the first ultrasonic transmission type may correspond to a first code and the second ultrasonic transmission type may correspond to a second code. In some examples, the first ultrasonic transmission type may correspond to a first frequency and the second ultrasonic transmission type may correspond to a second frequency. According to some examples, the ring control system may be configured to control the first transducer to produce the first ultrasonic transmissions while controlling the second transducer to produce the second ultrasonic transmissions.

According to some examples, an apparatus that is performing the method 1100 may include a flexible portion that resides between the first transducer and the second transducer. In some examples, the apparatus that is performing the method 1100 may include, for example as part of the ring control system and/or of a ring interface system—a flexible printed circuit board (PCB). In some such examples, at least a portion of the flexible PCB may reside between the first ultrasonic transmitter and the second ultrasonic transmitter. In some such examples, e.g., as shown in FIG. 9B, the first ultrasonic transmitter and the second ultrasonic transmitter may be piezoelectric transducers that each have a ring-shaped portion that is configured to extend at least partially around a wearer's finger and an extension that is configured to extend along at least a portion of the wearer's finger, for example, inside a transducer groove. In some such examples, the extensions may be configured to extend over, and to make electrical contact with, a portion of a flexible PCB. However, in some examples the first ultrasonic transmitter, the second ultrasonic transmitter, or both, may be micro-electromechanical system (MEMS) transducers.

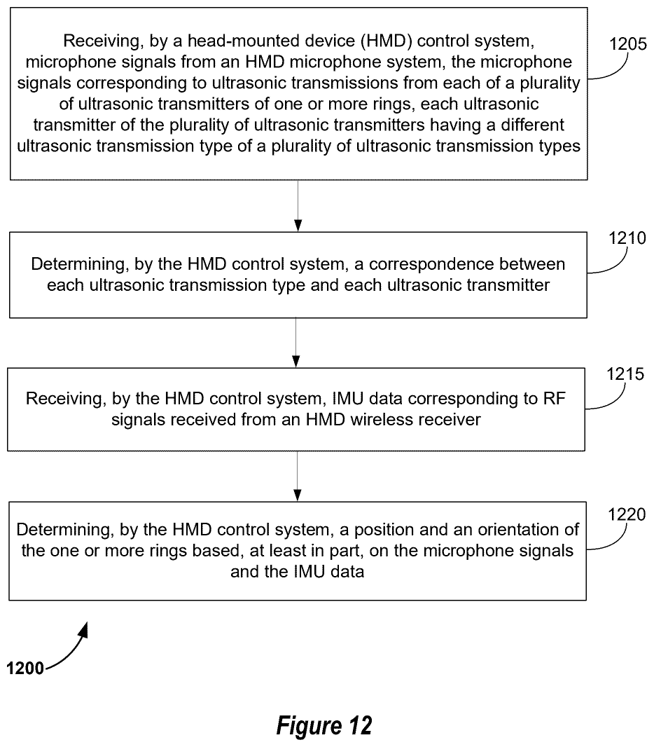

FIG. 12 is a flow diagram that presents examples of operations according to some additional disclosed methods. The blocks of FIG. 12 may, for example, be performed by the apparatus 201 of FIG. 2, by the apparatus 201 of FIG. 10A or FIG. 10B, or by a similar apparatus. For example, in some instances method 1200 may be performed, at least in part, by the control system 206 of FIG. 1. As with other methods disclosed herein, the methods outlined in FIG. 12 may include more or fewer blocks than indicated. Moreover, the blocks of methods disclosed herein are not necessarily performed in the order indicated. In some implementations, one or more blocks may be performed concurrently.

In this example, method 1200 is performed by an apparatus that is, or includes, a head-mounted device (HMD). According to this example, block 1205 involves receiving, by a head-mounted device (HMD) control system, microphone signals from an HMD microphone system. According to this example, the microphone signals correspond to ultrasonic transmissions from each of a plurality of ultrasonic transmitters of one or more rings. In this example, each ultrasonic transmitter of the plurality of ultrasonic transmitters has a different ultrasonic transmission type. There may be a plurality of ultrasonic transmission types. In some examples, each of the ultrasonic transmission types may correspond to a different code from that of the other ultrasonic transmission types. According to some examples, each of the ultrasonic transmission types may correspond to a different frequency from that of the other ultrasonic transmission types.

According to this example, block 1210 involves determining, by the HMD control system, a correspondence between each ultrasonic transmission type and each ultrasonic transmitter. Block 1210 may, for example, involve identifying each ultrasonic transmitter according to a code used by that ultrasonic transmitter, according to a frequency used by that ultrasonic transmitter, etc.

In this example, block 1215 involves receiving, by the HMD control system, IMU data corresponding to radio frequency (RF) signals received from an HMD wireless receiver. In some such examples, an apparatus performing the method 1200 may include a wireless receiver configured to receive RF signals, at least some of which corresponding to IMU data from an IMU of the one or more rings. The wireless receiver may be configured to provide IMU data corresponding to received RF signals to the HMD control system. At least some of the RF signals may be synchronized with the received ultrasonic transmissions.

According to this example, block 1220 involves determining, by the HMD control system, a position and an orientation of the one or more rings based, at least in part, on the microphone signals and the IMU data. In some examples, the one or more rings may be a single ring that includes the plurality of ultrasonic transmitters. In other examples, the one or more rings may include a plurality of rings. In some such examples, each ring of the plurality of rings may include one or more ultrasonic transmitters.

In some examples, method 1200 may involve determining a hand motion or a hand gesture based, at least in part, on microphone signals corresponding to ultrasonic transmissions from the one or more rings. Determining the position and the orientation of the one or more rings may involve a triangulation process that is based, at least in part, on the microphone signals. The determining process also may involve IMU data received from the one or more rings.

Implementation examples are described in the following numbered clauses:
1. An apparatus, including: a housing configured to be worn on at least a portion of a human hand or wrist; an inertial measurement unit (IMU) attached to the housing and configured to generate IMU data corresponding to an orientation of the apparatus; a wireless transmitter attached to the housing and configured to transmit radio frequency (RF) signals corresponding to the IMU data; an ultrasonic transmitter system attached to the housing and including one or more ultrasonic transmitters; and a control system attached to the housing and configured to: control a first ultrasonic transmitter of the ultrasonic transmitter system to produce first ultrasonic transmissions of a first ultrasonic transmission type; and control the wireless transmitter to transmit RF signals corresponding to the IMU data, the RF signals being synchronized with the first ultrasonic transmissions.
2. The apparatus of clause 1, where the apparatus is, or includes, a ring that is configured to be worn on a human digit.
3. The apparatus of clause 1 or clause 2, where the control system is further configured to control a second ultrasonic transmitter of the ultrasonic transmitter system to produce second ultrasonic transmissions of a second ultrasonic transmission type, the second ultrasonic transmissions being synchronized with the RF signals.
4. The apparatus of clause 3, where the first ultrasonic transmission type corresponds to a first code and the second ultrasonic transmission type corresponds to a second code.
5. The apparatus of clause 3 or clause 4, where the first ultrasonic transmission type corresponds to a first frequency and the second ultrasonic transmission type corresponds to a second frequency.
6. The apparatus of any one of clauses 1-5, where the control system includes a flexible printed circuit board and where at least a portion of the flexible printed circuit board resides between the first ultrasonic transmitter and the second ultrasonic transmitter.
7. The apparatus of any one of clauses 1-6, where a least one ultrasonic transmitter of the ultrasonic transmitter system is a micro-electromechanical system (MEMS) transducer.
8. The apparatus of any one of clauses 1-7, where at least one ultrasonic transmitter of the ultrasonic transmitter is a piezoelectric transducer.
9. The apparatus of any one of clauses 1-8, where the housing includes a flexible portion that resides between the first transducer and the second transducer.
10. The apparatus of any one of clauses 1-9, where the control system is configured to control the first transducer to produce the first ultrasonic transmissions while controlling the second transducer to produce the second ultrasonic transmissions.
11. A head-mounted device (HMD) configured as a headset or an eyeglass frame, the HMD including: a microphone system including three or more microphones; a display system; and a control system configured to: control the display system to provide extended reality effects; receive microphone signals from the microphone system, the microphone signals corresponding to ultrasonic transmissions from each of a plurality of ultrasonic transmitters of one or more rings configured to be worn on a human digit, each transmitter of the plurality of ultrasonic transmitters having a different ultrasonic transmission type of a plurality of ultrasonic transmission types; determine a correspondence between each ultrasonic transmission type and each ultrasonic transmitter; and determine a position and an orientation of the one or more rings based, at least in part, on the microphone signals.
12. The HMD of clause 11, further including a wireless receiver configured to receive radio frequency (RF) signals corresponding to inertial measurement unit (IMU) data from an IMU of the one or more rings and to provide IMU data corresponding to received RF signals to the control system, where the control system is further configured to determine the position and the orientation of the one or more rings based, at least in part, on the IMU data.
13. The HMD of clause 11 or clause 12, where the one or more rings includes a single ring that includes the plurality of ultrasonic transmitters or a plurality of rings, each ring of the plurality of rings including one or more ultrasonic transmitters.
14B. The HMD of clause 13, where the control system is further configured to determine a hand motion or a hand gesture based, at least in part, on microphone signals corresponding to ultrasonic transmissions from the one or more rings.
15. The HMD of any one of clauses 11-14, where each of the ultrasonic transmission types corresponds to a different code or a different frequency from that of the other ultrasonic transmission types.
16. The HMD of any one of clauses 11-15, where determining the position and the orientation of the one or more rings involves a triangulation process that is based, at least in part, on the microphone signals.
17. A system, including: a first ring that is configured to be worn on a human digit, the first ring including: an inertial measurement unit (IMU) configured to generate IMU data corresponding to an orientation of the apparatus; a wireless transmitter configured to transmit radio frequency (RF) signals corresponding to the IMU data; an ultrasonic transmitter system including one or more ultrasonic transmitters; and a first ring control system configured to: control a first ultrasonic transmitter of the ultrasonic transmitter system to produce first ultrasonic transmissions of a first ultrasonic transmission type; and control the wireless transmitter to transmit RF signals corresponding to the IMU data, the RF signals being synchronized with the first ultrasonic transmissions; and a head-mounted device (HMD) configured as a headset or an eyeglass frame, the HMD including: a microphone system including three or more microphones; a display system; a wireless receiver configured to receive radio frequency (RF) signals corresponding to inertial measurement unit (IMU) data from an IMU of one or more rings, the one or more rings including the first ring; an HMD control system configured to: control the display system to provide extended reality effects; receive microphone signals from the microphone system, the microphone signals corresponding to ultrasonic transmissions from each of a plurality of ultrasonic transmitters of one or more rings configured to be worn on a human digit, the one or more rings including the first ring, each ultrasonic transmitter of the plurality of ultrasonic transmitters having a different ultrasonic transmission type of a plurality of ultrasonic transmission types; determine a correspondence between each ultrasonic transmission type and each ultrasonic transmitter; receive IMU data from the wireless receiver corresponding to received RF signals; and determine a position and an orientation of the one or more rings based, at least in part, on the microphone signals and the IMU data.
18. The system of clause 17, where the HMD control system is further configured to determine a hand motion or a hand gesture based, at least in part, on microphone signals corresponding to ultrasonic transmissions from the one or more rings.
19. The system of clause 17 or clause 18, where the one or more rings includes a single ring that includes the plurality of ultrasonic transmitters or a plurality of rings, each ring of the plurality of rings including one or more ultrasonic transmitters.
20. The system of clause 19, where each of the ultrasonic transmission types corresponds to a different code or a different frequency from that of the other ultrasonic transmission types.

As used herein, a phrase referring to “at least one of” a list of items refers to any combination of those items, including single members. As an example, “at least one of: a, b, or c”is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations presented herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation.

Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order presented or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

1. An apparatus, comprising:
a housing configured to be worn on at least a portion of a human hand or wrist;
an inertial measurement unit (IMU) attached to the housing and configured to generate IMU data corresponding to an orientation of the apparatus;
a wireless transmitter attached to the housing and configured to transmit radio frequency (RF) signals corresponding to the IMU data;
an ultrasonic transmitter system attached to the housing and comprising one or more ultrasonic transmitters; and
a control system attached to the housing and configured to:
control a first ultrasonic transmitter of the ultrasonic transmitter system to produce first ultrasonic transmissions of a first ultrasonic transmission type; and
control the wireless transmitter to transmit RF signals corresponding to the IMU data, the RF signals being synchronized with the first ultrasonic transmissions.

2. The apparatus of claim 1, wherein the apparatus comprises a ring that is configured to be worn on a human digit.

3. The apparatus of claim 1, wherein the control system is further configured to control a second ultrasonic transmitter of the ultrasonic transmitter system to produce second ultrasonic transmissions of a second ultrasonic transmission type, the second ultrasonic transmissions being synchronized with the RF signals.

4. The apparatus of claim 3, wherein the first ultrasonic transmission type corresponds to a first code and the second ultrasonic transmission type corresponds to a second code.

5. The apparatus of claim 3, wherein the first ultrasonic transmission type corresponds to a first frequency and the second ultrasonic transmission type corresponds to a second frequency.

6. The apparatus of claim 1, wherein the control system comprises a flexible printed circuit board and wherein at least a portion of the flexible printed circuit board resides between the first ultrasonic transmitter and the second ultrasonic transmitter.

7. The apparatus of claim 1, wherein a least one ultrasonic transmitter of the ultrasonic transmitter system is a micro-electromechanical system (MEMS) transducer.

8. The apparatus of claim 1, wherein at least one ultrasonic transmitter of the ultrasonic transmitter is a piezoelectric transducer.

9. The apparatus of claim 1, wherein the housing includes a flexible portion that resides between the first transducer and the second transducer.

10. The apparatus of claim 1, wherein the control system is configured to control the first transducer to produce the first ultrasonic transmissions while controlling the second transducer to produce the second ultrasonic transmissions.

11. A head-mounted device (HMD) comprising a headset or an eyeglass frame, the HMD comprising:
a microphone system comprising three or more microphones;
a display system; and
a control system configured to:
control the display system to provide extended reality effects;
receive microphone signals from the microphone system, the microphone signals corresponding to ultrasonic transmissions from each of a plurality of ultrasonic transmitters of one or more rings configured to be worn on a human digit, each transmitter of the plurality of ultrasonic transmitters having a different ultrasonic transmission type of a plurality of ultrasonic transmission types;
determine a correspondence between each ultrasonic transmission type and each ultrasonic transmitter; and
determine a position and an orientation of the one or more rings based, at least in part, on the microphone signals.

12. The HMD of claim 11, further comprising a wireless receiver configured to receive radio frequency (RF) signals corresponding to inertial measurement unit (IMU) data from an IMU of the one or more rings and to provide IMU data corresponding to received RF signals to the control system, wherein the control system is further configured to determine the position and the orientation of the one or more rings based, at least in part, on the IMU data.

13. The HMD of claim 11, wherein the one or more rings comprises a single ring that includes the plurality of ultrasonic transmitters or a plurality of rings, each ring of the plurality of rings including one or more ultrasonic transmitters.

14. (canceled)

15. The HMD of claim 11, wherein each of the ultrasonic transmission types corresponds to a different code or a different frequency from that of the other ultrasonic transmission types.

16. The HMD of claim 11, wherein determining the position and the orientation of the one or more rings involves a triangulation process that is based, at least in part, on the microphone signals.

17. A system, comprising:
a first ring that is configured to be worn on a human digit, the first ring comprising:
an inertial measurement unit (IMU) configured to generate IMU data corresponding to an orientation of the apparatus;
a wireless transmitter configured to transmit radio frequency (RF) signals corresponding to the IMU data;
an ultrasonic transmitter system comprising one or more ultrasonic transmitters; and
a first ring control system configured to:
control a first ultrasonic transmitter of the ultrasonic transmitter system to produce first ultrasonic transmissions of a first ultrasonic transmission type; and
control the wireless transmitter to transmit RF signals corresponding to the IMU data, the RF signals being synchronized with the first ultrasonic transmissions; and
a head-mounted device (HMD) comprising a headset or an eyeglass frame, the HMD comprising:
a microphone system comprising three or more microphones;
a display system;
a wireless receiver configured to receive radio frequency (RF) signals corresponding to inertial measurement unit (IMU) data from an IMU of one or more rings, the one or more rings including the first ring;
an HMD control system configured to:
control the display system to provide extended reality effects;
receive microphone signals from the microphone system, the microphone signals corresponding to ultrasonic transmissions from each of a plurality of ultrasonic transmitters of one or more rings configured to be worn on a human digit, the one or more rings including the first ring, each ultrasonic transmitter of the plurality of ultrasonic transmitters having a different ultrasonic transmission type of a plurality of ultrasonic transmission types;
determine a correspondence between each ultrasonic transmission type and each ultrasonic transmitter;
receive IMU data from the wireless receiver corresponding to received RF signals; and
determine a position and an orientation of the one or more rings based, at least in part, on the microphone signals and the IMU data.

18. The system of claim 17, wherein the HMD control system is further configured to determine a hand motion or a hand gesture based, at least in part, on microphone signals corresponding to ultrasonic transmissions from the one or more rings.

19. The system of claim 17, wherein the one or more rings comprises a single ring that includes the plurality of ultrasonic transmitters or a plurality of rings, each ring of the plurality of rings including one or more ultrasonic transmitters.

20. The system of claim 19, wherein each of the ultrasonic transmission types corresponds to a different code or a different frequency from that of the other ultrasonic transmission types.

21. The HMD of claim 13, wherein the control system is further configured to determine a hand motion or a hand gesture based, at least in part, on microphone signals corresponding to ultrasonic transmissions from the one or more rings.
